(19) United States
(12) Patent Application Publication
(10) Pub. No.: US 2015/0170152 A1
(43) Pub. Date: Jun. 18, 2015

(54) SYSTEM AND METHOD FOR PROVIDING ACTIONABLE INPUT BASED ON SOCIAL MEDIA

(71) Applicant: Avaya Inc., Basking Ridge, NJ (US)

(72) Inventors: Shmuel Shaffer, Palo Alto, CA (US); Reinhard P. Klemm, Basking Ridge, NJ (US); David Skiba, Golden, CO (US)

(73) Assignee: Avaya Inc., Basking Ridge, NJ (US)

(21) Appl. No.: 14/104,471

(22) Filed: Dec. 12, 2013

(51) Int. Cl. G06Q 30/00; H04L 12/58; G06Q 50/00

(52) U.S. Cl. CPC G06Q 30/016; G06Q 50/01; H04L 51/32

(57) ABSTRACT

A contact center system can receive messages from social media sites or centers. The messages may include a problem encountered by a customer. The system can review messages to identify the problem and any solution provided in the social media. The system may then automatically retrieve, store, and repurpose the solution. Thus, the system uses the discovered solution to respond to future occurrences of the problem.

### BACKGROUND

Communication with customers and the importance of addressing customer concerns continues to grow in importance. Many companies conduct periodic or ongoing customer surveys with the goal of improving customer satisfaction. One common problem with most of the existing surveys is that the surveys may highlight generic issues but usually do not provide sufficient specifics regarding mitigating specific issues. More specific information is required to translate the survey answers input into a series of action items leading to remedial actions. To translate the dissatisfaction of customers into actionable items, companies at times contact users in person. Other than being time consuming and not guaranteeing desirable customer participation rates, direct contact with customers has another shortcoming—it relies on the dissatisfied customer to know how to resolve the issue. By only talking with a small set of dissatisfied customers, the organization does not tap into the vast experience of other customers (both its own customers as well as customers of their competitors). There needs to be a better method for efficiently determining actionable items and resolutions.

### SUMMARY

It is with respect to the above issues and other problems that the embodiments presented herein were contemplated. Embodiments include a method comprising: a processor detecting a problem associated with a social media message; the processor identifying a solution provided for the problem in social media associated with the social media message; and the processor automatically repurposing the solution.

An aspect of the above method includes wherein the problem is a concern of a customer or person about a company's product or service.

An aspect of the above method includes wherein the solution is information or media that addresses the concern.

An aspect of the above method includes wherein the problem is characterized using an internal dialog of a company.

An aspect of the above method includes wherein the problem is previously identified in a previous social media message.

An aspect of the above method includes wherein characteristics of the problem are retrieved from a database to detect the problem in the social media message.

An aspect of the above method includes wherein the solution is stored in the database.

An aspect of the above method includes wherein repurposing the solution includes changing a script or dialog used by an agent or by a system to respond to the problem.

An aspect of the above method includes wherein repurposing the solution includes quoting the solution in response to a second social media message also including the problem.

An aspect of the above method includes wherein repurposing the solution includes providing the solution to an agent to respond to a customer.

Embodiments include a computer readable medium having stored thereon processor executable instructions that cause a computing system to execute a method, the instructions comprising: instructions to identify a problem associated with a customer of a company; instructions to detect the problem associated with a social media message; instructions to identify a solution provided for the problem in social media associated with the social media message; instructions to store the solution in a database; and instructions to repurpose automatically the solution.

An aspect of the above computer readable medium includes wherein the problem is a concern of the customer about a company's product or service, and wherein the solution is information or media that addresses the concern.

An aspect of the above computer readable medium includes wherein the problem is identified by one of: characteristics found in an internal dialog of the company; or characteristics found in a previous social media message that identified the problem.

An aspect of the above computer readable medium includes wherein the characteristics of the problem are retrieved from the database to detect the problem in the social media message.

An aspect of the above computer readable medium includes wherein repurposing the solution includes one of: changing a script or dialog used by an agent or by a system to respond to the problem; quoting the solution in response to a second social media message also including the problem; or providing the solution to the agent to respond to the customer.

Embodiments include a communication system comprising: a social media gateway in communication with a social media network, the social media gateway operable to receive a social media message on the social media network; a dialog system in communication with the social media gateway, the dialog system operable to analyze the social media message, wherein the dialog system compromises: an analysis tools component that is operable to receive and analyze the social media message, wherein the analysis tools component compromises: a problem identifier operable to identify a problem associated with a customer of a company; a problem assignor operable to detect the problem associated with a social media message a solution identifier operable to: identify a solution provided for the problem in social media associated with the social media message; store the solution in a database; and a repurposing engine operable to repurpose automatically the solution.

An aspect of the above communication system includes wherein the problem is a concern of the customer about a company's product or service, and wherein the solution is information or media that addresses the concern.

An aspect of the above communication system includes wherein the problem identifier identifies the problem by one of: characteristics found in an internal dialog of the company; or characteristics found in a previous social media message that identified the problem.

An aspect of the above communication system includes wherein the problem assignor retrieves the characteristics of the problem from the database to detect the problem in the social media message.

An aspect of the above communication system includes wherein the repurposing engine repurposes the solution by one of: changing a script or dialog used by an agent or by a system to respond to the problem; quoting the solution in response to a second social media message also including the problem; or providing the solution to the agent to respond to the customer.

A company can use a social media and Web mining systems, such as the existing Avaya Social Media Manager (SMM), to scan online public social networks and Web forums for mention of the company's name(s) and/or mention of the company's product, service, and/or trademarks. As the system finds online user comments associated with the company, the social media or Web mining systems classifies the comments based on the satisfaction level they project with the products and services offered by the company. The system then can provide reports advising the company about its users' level of satisfaction.

The social media or Web mining systems can be enhanced. Specifically, the social media or Web mining systems can scan online (e.g., social, Web) forums for comments from customers dissatisfied with the company's products and services. For example, the social media or Web mining systems may scan the company's Facebook Page for particular comments and Tweets that mention the company. Second, the social media or Web mining systems may parse these comments and capture any remedy, solution, or answer suggested by the users in the comments. As an example, the social media or Web mining systems can identify the comment: “The word processor kept crashing when I opened large documents but when I turned off the spell checker, and it didn't happen anymore.” The social media or Web mining systems may provide this input to a set of designated contacts (e.g., QA, legal, marketing, PR, product departments or a contact center) in the company. As another example, a restaurant may see discussion on sites like Yelp complaining about the ambience of the waiting area and suggestions for redoing the decor. The company could the enhancement its appeal by making a small investment and changing the furniture in the waiting room.

In another circumstance, for comments expressing problems with a product or service of the company without a stated remedy, solution, or answer, the social media or Web mining system can scan online forums for comments related to the same product or service. When it finds comments that suggest a remedy, solution, or answer, such as, “I had a similar issue, and I used the XYZ utility to resolve the issue,” the social media or Web mining system can capture the suggestion(s) and provide them to the designated contacts in the company. The contacts may then follow up with users whose comments in online forums indicate problems but no solution.

The social media or Web mining system may also scan online forums that are not necessarily related to the company or the company's products or services, and to identify cross-forum visibility into actionable comments by users who are in such forums. For example a Twitter user may share a positive experience and report how good he felt when a call center agent asked him about his Thanksgiving dinner. As a result the system may alert the call center and advise its agents to insert into their conversation a statement like “I hope you had a great Thanksgiving dinner last night”. Similarly, if the system detects an open question on one forum and a similar question with an answer on a different forum, the social media or Web mining system can propagate the answer to the question between the public forums, thus, accelerating the resolution and increasing customer satisfaction.

Further, the social media or Web mining system may scan online forums for positive feedback about competing companies, products, and services, such as, “I'm very pleased with the blue cover of my new phone; it really brightens my office.” This type of input can generate product roadmap modifications and may present the company with an opportunity to consider a different or modified product line.

Businesses routinely have to respond to questions from the public (their customers and others) as part of customer service operations and other business functions that face the public. Conversely, businesses often would like to ask their customers questions as part of quality assurance efforts to increase customer satisfaction or to understand their customers' needs and preferences. Finding answers to customer or business questions can be difficult. Customer service operations rely on business-internal knowledge to find answers to customer questions, and businesses conduct different types of surveys (group, individual, online, mail, in response to a purchase or asynchronously, etc.) to receive the desired feedback from customers. In both scenarios, finding the answers that the business is looking for tends to be time-consuming and labor-intensive. Moreover, business-internal sources of knowledge often do not contain the best and sometimes no answer to a customer's question, and customer surveys often do not provide the detailed input that the business is truly interested in to take remedial action. In both scenarios, the business typically has or gains access to only a small knowledge corpus that limits the quality of insights to be gained.

In addition to the above-stated goals, the system described herein helps to mitigate the time, effort, and money required to find the actionable answers that a business is looking for and to considerably widen the knowledge corpus from which to draw the answers. To do so, the system acts as a brokerage between questions—from the public as well as inside the business—and potential answers retrieved from the vast amount of posts on social networks and other online forums. In one direction, questions and “musings” on business-internal blogs, private social networks, and forums are matched with input from the public on public social networks and other online forums. In the other direction, questions from the public can be matched with answers on public social networks and from business-internal sources (subject to a public disclosure screening process). The matching is based on a semantic analysis of posts and results in a response that identifies the brokerage as the “matchmaker” and the posting user as the source.

The final aspect of this system is that as these questions/answers can be learned, either from an agent actually answering or a match being made; the broker service may attempt to proactively search other sites or locations known to list problems for places to apply the newly found answers.

The following provide examples of how the system may operate:

1. A quality assurance (QA) engineer E posts: “I wonder whether customers have noticed an unusual failure rate with our new X product,” on the business' internal Chatter social network. The brokerage mines certain public social media venues for mention of the business name, the product name (“X”), and the keywords “error”, “fail”, “problem”, “fix”, etc. The brokerage might find customer posts on the business' Facebook page, for example, this post from customer Y: “I bought X from Amazon. The installation was simple, but my X broke after only two days of light use. I was able to get it to work again by unplugging it, waiting for 15 minutes, and plugging it back in. I'm very disappointed, though.” The brokerage would respond to E's post with a comment: “We found a match for your posting: customer Y posted ‘[quote of the post]’ on Facebook.” E would not only learn that her suspicions are justified but also potential steps to identify the circumstances under which X breaks and potential remedies.

2. A customer Z tweets: “X sucks—tried it, and it broke in no time. What do I do?” The brokerage can find the same Facebook post from Y and reply to Z's Tweet with another Tweet in which it quotes Y's post, including the ad hoc fix for the problem.

3. The brokerage system can learn from the question answer pair: “why is my flight CJ1234 delayed again?” The agent responds with: “CJ1234 has a mechanical failure and will be 4 hours late.” After the exchange has occurred, the brokerage service may proactively use a query to find any other questions related to CJ1234 and see if the new answer fits. The service may check other places like twitter, fb, flyertalk, and a specific travel forum to make use of this new answer. Since the query term may be different than the typical operational queries or account based monitoring done this could yield other questions previously missed.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “problem” can refer to a concern of a customer or person about a company's product or service.

The term “solution” can refer to information or media that addresses a concern of a customer or person about a company's product or service.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation, or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects can be separately claimed.

The term “in communication with” as used herein refers to any coupling, connection, or interaction using electrical signals to exchange information or data, using any system, hardware, software, protocol, or format.

A user context, an extended user context, and/or a user social context as used herein means information about a user of a social media network that can be used to determine a “value” of that user.

The term “social media network” or “social media” is a service provider that builds online communities of people, who share interests and/or activities, or who are interested in exploring the interests and activities of others. Generally, social media are web-based and provide a variety of ways for users to interact, such as e-mail and instant messaging services.

### BRIEF DESCRIPTION OF THE DRAWINGS

The present disclosure is described in conjunction with the appended figures:

FIG. 1A is a block diagram of an embodiment of a communication system operable to interact with persons;

FIG. 1B is a block diagram of an embodiment of a communication system operable to interact with persons using a social media network;

FIG. 2A is a block diagram of an embodiment of a social media gateway;

FIG. 2B is a block diagram of an embodiment of a dialog system;

FIG. 3 is a block diagram of an embodiment of an analysis tools component;

FIG. 4 is a block diagram of an embodiment a data structure or database for storing past problems and auto responses information;

FIG. 5 is a flow diagram of an embodiment a process for identifying problems and solutions in social media;

FIG. 6 is a flow diagram of an embodiment a process for repurposing the solutions discovered in social media;

FIG. 7 is a block diagram of an embodiment of a computing environment; and

FIG. 8 is a block diagram of an embodiment of a computer system.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. Various changes may be made in the function and arrangement of elements of the embodiment without departing from the spirit and scope of the appended claims.

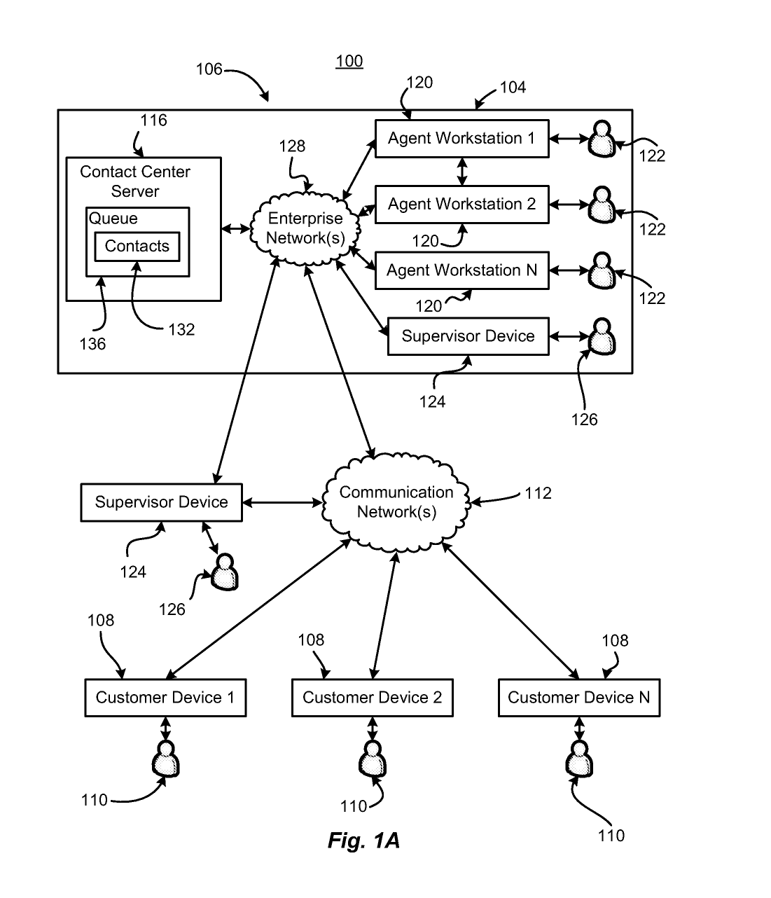

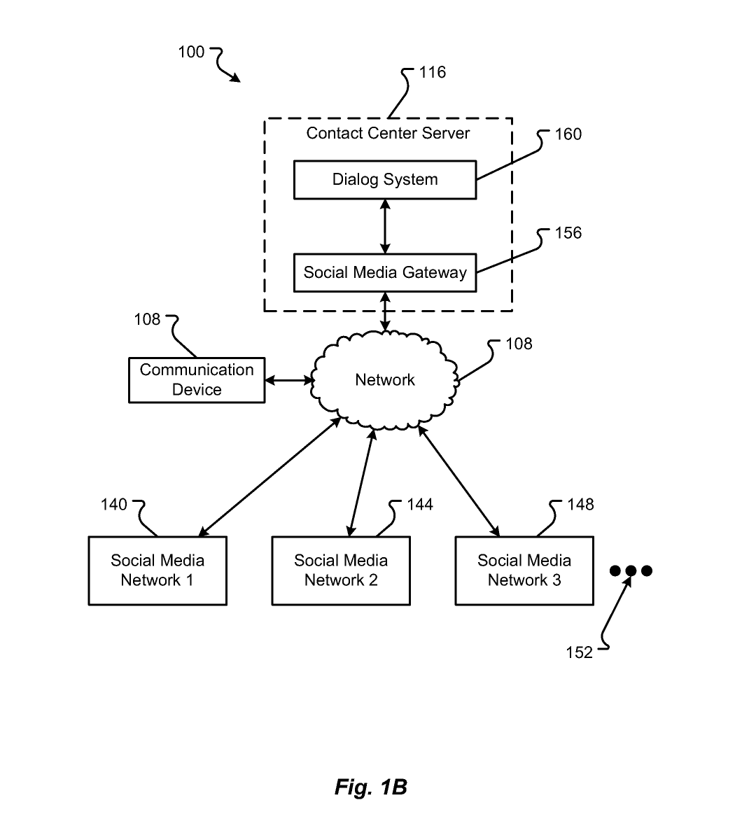

A block diagram depicting components of a communication system 100 is shown in FIG. 1A. In particular, the communication system 100 can include a contact center 104. In general, the contact center 104 can be in communication with one or more customer endpoints or devices 108 via one or more communication networks 112. Examples of customer endpoints 108 can include one or more of, but are not limited to, smartphones, desktop computers, laptop computers, or any other device capable of supporting communications between a customer and a customer service or other agent associated with the contact center 104 using written, oral, and/or electronic communications. Accordingly, communications between the contact center 104 and the customer endpoints 108 can comprise email, instant messaging, a telephone call, short message system, or other real time or non-real time communications. The communication network 112 can include the Internet, a local area network (LAN), wide area network (WAN), public switched telephone network (PSTN), wireless networks, or a plurality of networks in any combination.

The contact center 104 generally includes a call or contact center server 116, such as an automatic contact (or call) distribution system (ACD) server 116. The ACD server 116 is illustratively the Communication Manager™ enterprise communication-based ACD system available from Avaya Inc. The ACD server is interconnected to a plurality of agent workstations or endpoints 120. For example, the agent workstations 120 may be connected to the ACD server 116 by an enterprise network or networks 128.

The contact center server 116 generally functions to connect agent workstations 120 to customer devices or endpoints 108 through the communication network 112, to allow the agents 122 to service customer 110 contacts 132. The contacts can comprise written, electronic communications. However, contacts are not necessarily limited to written communications. For example, the contact center 106 can additionally handle voice contacts. As can be appreciated by one of skill in the art after consideration of the present disclosure, the contact center server 116 can maintain one or more queues 136 for organizing and maintaining or holding contacts 132 waiting for handling by a contact center agent 122. For example, a plurality of queues 136 can be provided to sort contacts according to various parameters. Agents 122 associated with the agent workstations 120 are assigned to provide services to contacts 132 that have been placed within one or more of the queues 136 based on availability and/or weighting factors. Moreover, the workstations 120, which can comprise general purpose computers, thin client devices, or other devices, generally support the delivery of customer contacts to associated agents 122, and to receive replies to the customer contacts from the agents 122. In addition, the agent workstations 120 can include a user output in the form of a display that can present a determined sentiment or sentiment indicator for a contact, or aggregation of contacts, to associated agents 122.

In addition, system 100, as described herein, can include one or more supervisor or administrator devices 124. The supervisor device 124 is generally in communication with the contact center server 116 via the communication network 112 and/or the enterprise network 128. For example, if the supervisor device 124 is on the premises of the contact center 104, communications with the contact center server 116 may be over a portion of the enterprise network 128 comprising a wired or wireless network. As another example, the supervisor device 124 may be in communication with the contact center server 116 over the communication network 112, for example via a cellular telephony data network, a wired or wireless connection outside of the enterprise network 128, or the like. In general, the supervisor device 124 comprises functionality that allows a supervisor 126 to monitor the health of the contact center 104, and to control aspects of the operation of the contact center 104. Moreover, the supervisor device 124 can present a sentiment indicator for a contact or aggregation of contacts to a supervisor 126. Accordingly, the supervisor device 124 can comprise any device, including a mobile device, capable of presenting information to a supervisor 126. Accordingly, examples of a supervisor device 124 include, but are not limited to, a tablet computer, a smartphone, a laptop computer, a desktop computer, a netbook, or the like.

A further embodiment of the communication system 100, for interacting with persons using social media, is shown in FIG. 1B. The communication system 100 can include a contact center 104, a network 128, 112, and one or more types of social media networks or systems, such as social media network 1 140, social media network 2 144, and/or social media network 3 148. Social media networks 140, 144, and/or 148 can be any social media including, but not limited to, networks, websites, or computer enabled systems. For example, a social media network may be MySpace™, Facebook™, Twitter™, Linked-In™, Spoke™, Sina Weibo, Pantip, or other similar computer enabled systems or websites. The communication system 100 can communicate with more or fewer social media networks 140, 144, and/or 148 than those shown FIG. 1B, as represented by ellipses 152.

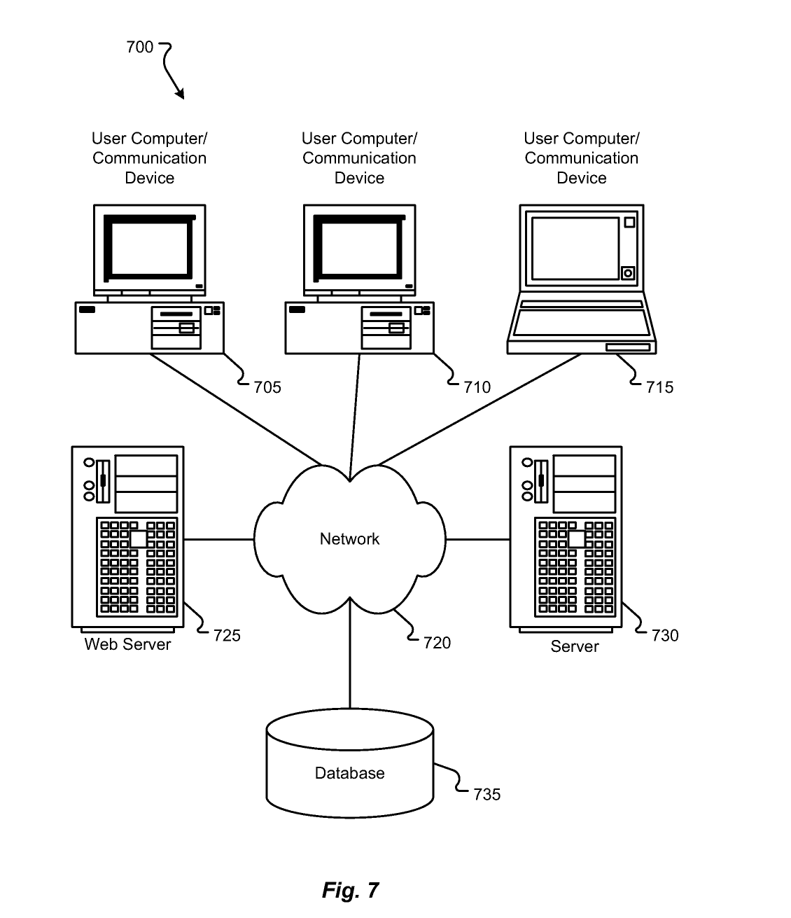

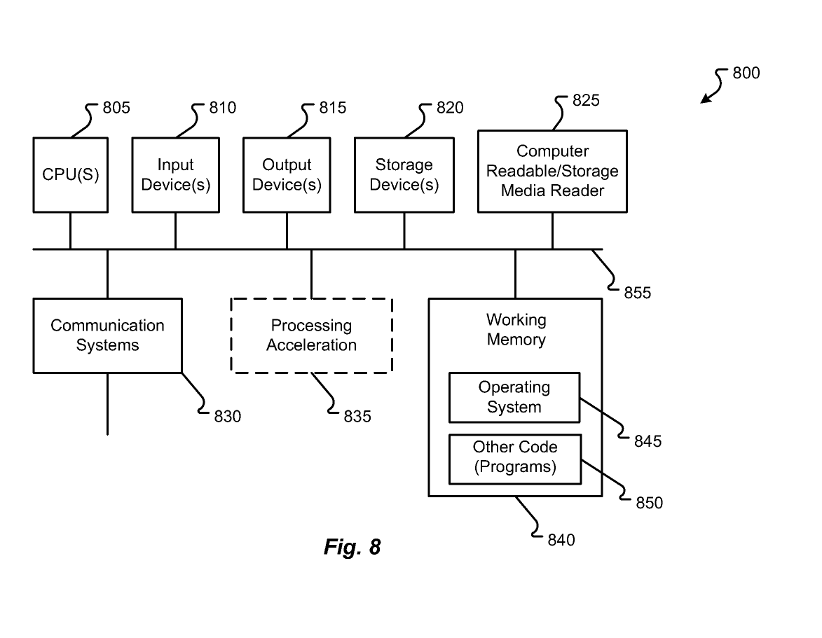

The network(s) 128, 112 can be any network, as described in conjunction with FIG. 1A, which allow communication between the contact center 116 and the one or more social media networks 140, 144, and/or 148. The network(s) 128, 112 can represent any communication system, whether wired or wireless, using any protocol and/or format. The network(s) 128, 112 provides communication capability for the contact center 116 to communicate with websites or systems corresponding to the one or more social media networks 140, 144, and/or 148. The network(s) 128, 112 may be as described in conjunction with FIGS. 7 and 8.

A contact center 116 can be a system that can communicate with one or more persons that use social media networking sites 112, 114, and/or 116. The contact center 116 can be hardware, software, or a combination of hardware and software. The contact center 116 can be executed by one or more servers or computer systems, as described in conjunction with FIGS. 7 and 8. The contact center 116 can include all systems, whether hardware or software, that allow the contact center 116 to receive, service, and respond to directed and non-directed contacts. For example, the contact center 116 can include the telephone or email system, an interface to human agents, systems to allow human agents to service and respond to received contacts, and one or more systems operable to analyze and improve the function of agent interaction.

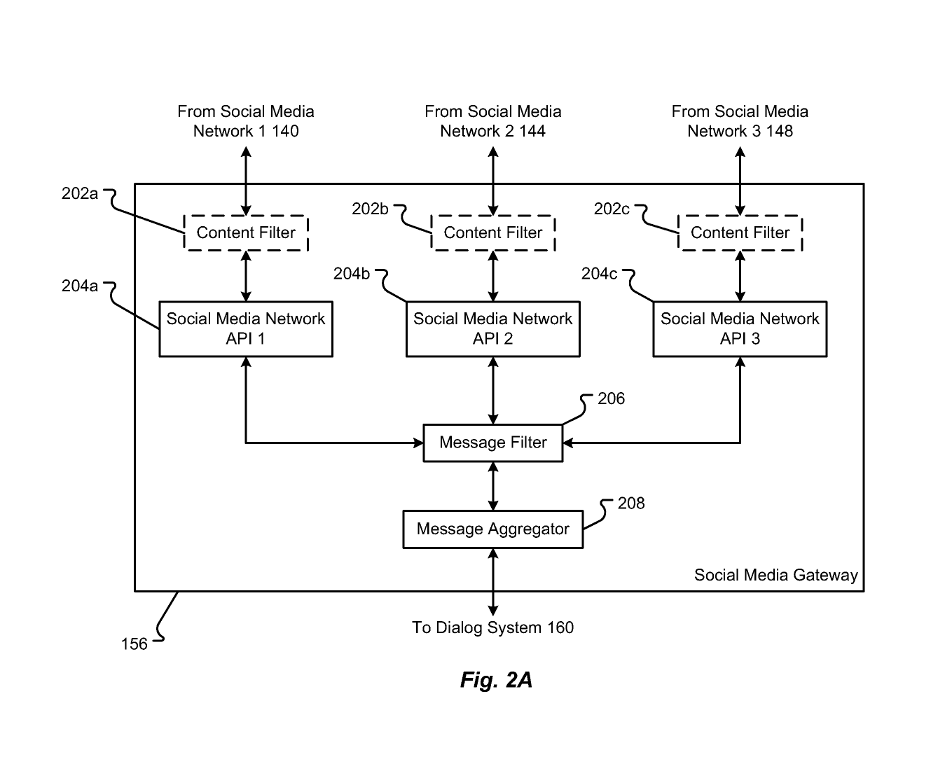

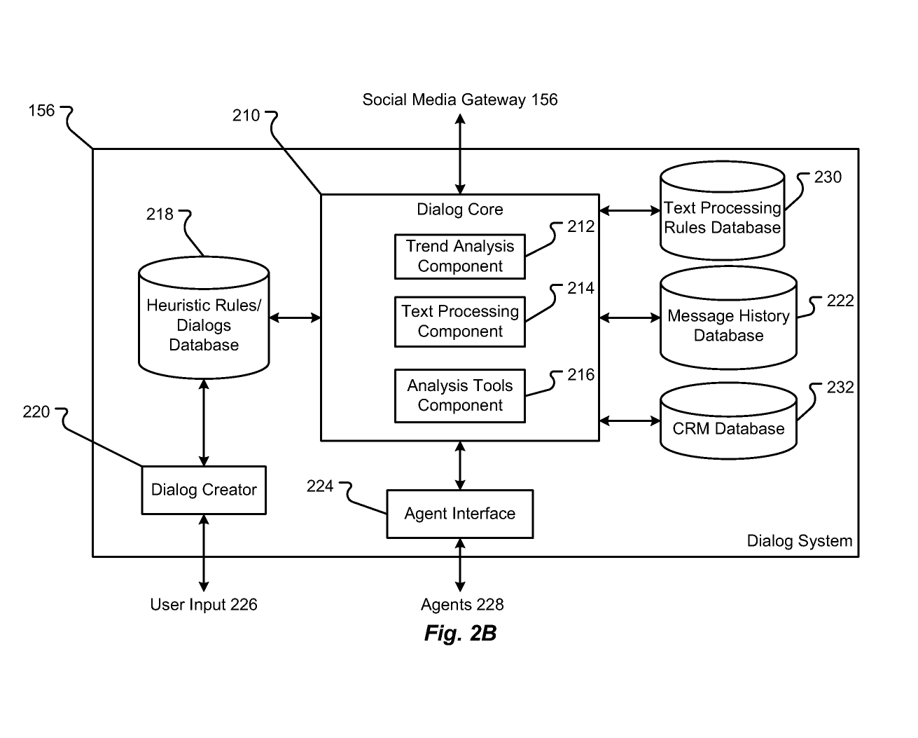

The contact center 116 may include a dialog system 160 and a social media gateway 156. While the dialog system 160 and the social media gateway 156 are shown as being a part of the contact center system 116, in other situations, the dialog system 160 and/or the social media gateway 156 are separate systems or functions executed separately from the contact center 116 and/or executed by a third party. The dialog system 160 may process and receive messages. The social media gateway 156 can receive and translate messages from the one or more social media networks 140, 144, and/or 148. An embodiment of the dialog system 160 is described in conjunction with FIG. 2B. An embodiment of the social media gateway 156 is described in conjunction with FIG. 2A.

The contact center 116 may also communicate with one or more communication devices 108. The communication devices 108 can represent a customer's or user's cell phone, email system, personal digital assistant, laptop computer, or other device that allows the contact center 116 to interact with the customer. The contact center 116 can modify a non-direct contact, from a social media network 140, 144, and/or 148, into a directed contact by sending a response message directly to a customer's communication device 108.

An embodiment of the social media gateway 156 is shown in FIG. 2A. The social media gateway 156 can include one or more components which may include hardware, software, or combination of hardware and software. The social media gateway 156 can be executed by a computer system, such as those described in conjunction with FIGS. 7 and 8. However, in other embodiments, the components described in conjunction with FIG. 2A are logic circuits or other specially-designed hardware that are embodied in a field programmable gate array (FPGA) application specific integrated circuit (ASIC), or other hardware.

Herein, the social media gateway 156 can include one or more content filters 202a, 202b, and/or 202c. A content filter 202 can receive all of the messages for the contact center 116 from a social media network 140, 144, and/or 148 and eliminate or delete those messages that do not require a response. For example, a message between two friends on a Facebook™ page, if not pertaining to a product or a service of the company operating the contact center 116, may not need a response. As such, the content filter 202 can filter out or delete the non-suitable message from the messages that are received by the social media network application programming interface (API) 1 204a, social media network API 2 204b, and/or social media network API 3 204c. With the content filter 202, the social media network API 204 only needs to convert to a common message format for those messages that should be received by the dialog system 160.

As an alternative or in conjunction with the embodiments described herein, the content filter 202 can translate or detect the use of the “latin” characters from the UNICODE Halfwidth and Fullwidth Forms block (e.g., the Cyrillic character represented by ‘&#x430’ in the Unicode character set appears identical to the Latin letter ‘a’). By substituting standard Latin characters for characters in the Halfwidth and Fullwidth Forms block (or similar), the poster may be seeking to defeat a string comparison or a regular expression matching method that may detect target words and/or phrases. To combat this type of character set spoofing, the content filter 202 can translate all the characters from the Halfwidth and Fullwidth Forms block (or similar) into a standard Latin representation before processing the message. Alternatively or additionally, the content filter 202 can “flag” (i.e., save an indication with the message of the translation or presence of the Halfwidth and Fullwidth Forms block) the message. The flag may be later used to determine if the posting is a troll post. The presence of Halfwidth and Fullwidth Forms block characters (or similar) may not always indicate that the message is a troll post because there may be cases where a non-native English user is legitimately attempting to create a message and uses a mix of standard Latin characters and characters from their language range. The translation or flagging of the message may also assist in evaluating the similarity of user names when someone is trying to spoof the detection by using alternative Latin characters in the creation of their username.

The content filter 202 is provided with one or more heuristics or filter rules from a filter database (not shown). These filter rules can be created by the external customer or internal user (e.g. agent or administrator) of the communication system 100. Thus, the user or customer of the communication system 100 can customize the filtering of messages from social media networks 140, 144, and/or 148. Further, different rules may be applied to different social media networks 140, 144, and/or 148, as some social media networks 140, 144, and/or 148 may have different types of messages or postings than other types of social media networks 140, 144, and/or 148. While the content filter 202 is shown as part of the social media gateway 156, it is to be appreciated that the content filter 202 may be a part of the social media network API 204. The content filter 202 may correspond to query terms used by the social media network API 204. The content filter 202 or query terms are an argument to the social media network API 204 call.

The social media network API 204 can be an application, which may be provided by the social media network 140, 144, and/or 148, to access the social media network(s) 140, 144, and/or 148. Thus, the social media network API 204 is called and connects the social media gateway 156 to the social media network 140, 144, and/or 148. Any suitable filter criteria may be employed for social media API 204. Examples of filter criteria include positive content of the source of a posting, an address field, a destination or recipient address fields, a time stamp field, a subject matter field, and/or a message body field. For example, a type of searchable content can be the name of the business enterprise running or employing the contact center 116 and/or the products or services of the enterprise.

The social media gateway 156 can include one or more social media network APIs 204. As shown in FIG. 2A, the social media gateway 156 may include a social media network API 204 for each social media network 140, 144, and/or 148. As such, the social media gateway 156 can interact with each social media network 140, 144, and/or 148 in the particular (often unique) format or protocol used by the social media network 140, 144, and/or 148. Further, when new social media networks are created, the social media gateway 156 can be easily expanded to interact with those social media networks by adding another social media network API 204. Where social media networks 140, 144, and/or 148 are more standardized, or use substantially similar formats or protocols, a single social media network API 204 can be shared by multiple social media networks 140, 144, and/or 148.

The social media network API 204 can receive messages from and send messages to the social media network 140, 144, and/or 148. The social media network API 204 can translate a message received from a social media network 140, 144, and/or 148 and send the translated message to a message filter 206. The social media network API 204 can translate the received message into a standard formatted file. For example, the translated message may be represented by an extensible mark-up language (XML) file or other file having a general format. As such, each specific and particular social media network message can be translated into a standard format for use by the dialog system 160. Further, the social media network API 204 can receive a generally or standard format response message, from the dialog system 160, and translate that response into a particularly or specifically formatted response message that can be posted to the corresponding social media network 140, 144, and/or 148.

Messages to the contact center 116 are addressed to the contact center 116. For example, a customer may become a “friend” of the contact center 116 on a social media network 140, 144, and/or 148, such as Facebook™. The customer may then address a message to the contact center 116 on Facebook™. This non-direct contact is a message that is not sent directly to the contact center 116 but to the contact center's Facebook™ page. In other circumstances, the contact center 116 receives messages not addressed to the contact center 116. For example, the contact center 116 can receive tweets from Twitter™ that are “broadcast” rather than addressed to the contact center 116. The contact center 116 may also search for messages or content on the social media networks 140, 144, and/or 148. Exemplary search criteria include customer name, customer profession, customer home address, customer business address, customer employer name, customer educational or professional background, customer hobby, personal or business interests, customer family profile, and the like. Thus, the social media gateway 156 of the contact center 116 can query, gather, or connect to a live feed of data from a social media network 140, 144, and/or 148 and then apply a filter to the indirect information.

Further, the social media network API 204 can also retrieve user context or other extended information from the social media networks 140, 144, and/or 148. User context or other extended information can include historical posts, historical tweets, or other historical communications that a user may have received or sent. Further, user context or other extended information can include, but is not limited to, account information for a user, the user's followers or friends, information on where historical messages were posted (e.g., geo-location, time/date, what type of device, etc.), trending analysis that the social media network 140, 144, and/or 148 might provide the user, etc. Thus, the social media network API 204 can retrieve information that is associated with a user and a social media network 140, 144, and/or 148 but not necessarily a part of a current message. The social media network API 204 is a gatherer of data, which can be used to determine a value for the user of the social media networks 140, 144, and/or 148.

The translated messages from the social media network API 204 can be received by a message filter 206. A message filter 206 can perform some or all of the functions of the content filter 202 and eliminate messages before being sent to the dialog system 160. However, in other situations, the message filter 206 eliminates information from within the messages before the redacted messages are sent to the dialog system 160. For example, a message from a social media network 140, 144, and/or 148 may have three or four interactions between two parties not associated with the contact center 116. Only one of the several postings may be pertinent to the dialog system 160. As such, the message filter 206 can eliminate or delete at least a portion of the other messages for the dialog system 160. Thus, the dialog system 160 receives a message where some of the content of the message has been deleted.

The message filter 206 can retrieve heuristics or filter rules from a filter database (not shown), similar to the content filter 202. A substantial difference between the content and message filters 202 and 206 is that the content filter 202 is specific to a particular message format associated with a corresponding social media network 140, 144, and/or 148, while the message filter 206 is applied to a standardized or universal format and is therefore common to multiple social media networks 140, 144, and/or 148. One skilled in the art will understand the type of rules that may be used to filter information from messages such that only pertinent questions, facts, requests, or information is sent to the dialog system 160.

A message aggregator 208 may also be included with the social media gateway 156. A message aggregator 208 can, in contrast to the message filter 206, combine two or more messages into a packet or grouping that is sent to the dialog system 160. Therefore, the message aggregator 208 can interrelate or combine messages based on information within the messages. For example, two messages may be combined based on any of the message fields referenced above, such as the person that posted the message, the subject, the request or question asked, the person the message was sent to, or other information that may be pertinent to the dialog system 160. Thus, the dialog system 160 may be able to respond concurrently to two or more messages based on a grouping provided by the message aggregator 208. Regardless of whether the messages are aggregated, each message or grouping of messages can be sent from the social media gateway 156 to the dialog system 160.

The social media gateway 156 can also send responses back to the social media networks 140, 144, and/or 148. A response from an agent in the contact center 116 can be sent to the social media gateway 156. The response may be received in a general format and then translated. The translated response may then be posted to the appropriate social media network 140, 144, and/or 148 by the social media gateway 156. In other embodiments, the agent may post the response directly to the social media network 140, 144, and/or 148 without sending the response to the social media gateway 156.

An embodiment of the dialog system 160 is shown in FIG. 2B. The dialog system 160 can include one or more components which may be hardware, software, or a combination of hardware and software. The dialog system 160 can be executed by a computer system such as those described in conjunction with FIGS. 7 and 8. However, in other embodiments, the components described in conjunction with FIG. 2B, are logic circuits or other specially-designed hardware that are embodied in a FPGA or ASIC. The components contained within the dialog system 160 can include a dialog core 210 that is communication with a message history database 222, an agent interface 224, and a heuristic rules and dialogs database 218. Further, the heuristic rules and dialogs database 218 can be in communication with a dialog creator 220.

The dialog core 210 can include one or more sub-components. For example, the dialog core 210 can include a trend analysis component 212, a text processing component 214, and an analysis tools component 216. These components, similar to the components for the dialog system 160, can be hardware, software, or combination of hardware and software. The dialog core 210 may step through the states of a dialog data structure. A dialog data structure can include a set of inputs and associated actions that can be taken which allow for the automatic and structured response to social media requests or messages. For example, if a user asks for a manual, the input of the text word “manual” can cause the dialog system 160, in accordance with a dialog data structure, to send information about one or more manuals. In turn, the receiver of the response may respond, in kind, with the selection of a certain user manual. In which case, the dialog data structure may then instruct the dialog core 210 to send the user to a website where the user can retrieve an electronic version of the manual. As such, the dialog data structure provides a script a dialog that allows the dialog core 210 to automate the interaction between the contact center 116 and a person. This automation eliminates the need for agent involvement, in some situations, and makes the contact center 116 more efficient and more effective. Further, the automation expands the contact center's ability to answer numerous messages from the plethora of postings on the numerous social media networks 140, 144, and/or 148.

The dialog creator 220 can create a dialog data structure that includes instructions for various states for each social media message that comes into the contact center 116. The first instruction might be to send the social media message to the trend analysis component 212, then to the text processing component 214, and then execute a query of a Customer Relationship Management (CRM) database 232 (to determine if this user has an existing order). A CRM database 232 can be a database as described in conjunction with FIGS. 7 and 8 and can store information about customers or other data related to customer relations. Finally, the dialog data structure 220 may decide that the social media message should be sent to a human agent 228 for processing. The instructions or node transitions are executed in the dialog core 210 and make use of many different components that the dialog creator 220 combines in any way the user desires to handle the social media messages. The dialog core 210 can make use of the trend analysis component 212, text processing component 214, or other systems. The dialog core 210 may also interface with a CRM system and/or database 232, external databases, social media user information (e.g., followers, friends, post history, etc. from the social media site), or other systems.

The trend analysis component 212 is operable to analyze trends that occur between two or more messages received by the social media networks 140, 144, and/or 148. The two messages can be from different social media network 140, 144, and/or 148, so that the trend analysis component 212 can identify trends across several different social media networks 140, 144, and/or 148. Trends can include multiple occurrences of the same word or phrase, multiple occurrences of a customer identity, product name or service, or multiple occurrences of some other information that might indicate a trend. Further, the trend analysis component 212 may be able to identify escalations in the occurrences of particular text, identities, or other information, or may identify multiple occurrences over a period of time. The trend analysis component 212 may also be able to apply one or more different algorithms to occurrences of information within the social media networks 140, 144, and/or 148. For example, the trend analysis component 212 can match the number of occurrences of a phrase or word over a period of time and apply analysis to determine if the occurrences are increasing or decreasing over the period of time.

The text processing component 214 is operable to analyze text of one or more messages from social media networks 112, 114, or 116 or other contacts. Some possible methods for text processing can include Regular Expression, Latent Semantic Indexing (LSI), text part of speech tagging, text clustering, N-Gram document analysis, etc. In addition, for possibly longer documents, (such as, blogs or emails), the text processing component 214 may execute one or more methods of document summarization. The summarization may occur if the social media message will be sent to an agent 228 of the contact center 116; the summarization can reduce the amount of information that the agent 228 may manage. The text processing rules or models may be stored in and/or retrieved from a text processing rules database 230. The text processing rules database 230 can be a database as described in conjunction with FIGS. 7 and 8 that stores rules or models used by the text processing component 214.

The text processing component 214 can identify one or more occurrences of a particular text, such as using one or more of the message fields referenced above, in order to associate that social media message with one or more dialogs data structures in the heuristic rules and dialog database 218. For example, the text processing component 214 can look for the word “manual,” in the social media message. If the word “manual” is found, the text processing component 214 may retrieve a dialog data structure from the heuristic rules and dialogs database 218 and, as the dialog data structure instructs, communicate with the customer about one or more owner's manuals, repair manuals, or other types of manuals. In another example, if the social media message includes the words, “buy”, “sell”, “price, “discount” or other types of words that may indicate the user or customer wishes to buy a product, the text processing component 214 can retrieve one or more dialog data structures from the heuristic rules and dialogs database 218 that can provide instruction to assist the customer in purchasing products or services from the enterprise.

The analysis tools component 216 is operable to analyze response messages received back from an agent interface 224. In analyzing the agent's responses, the analysis tools component 216 can determine if the dialog data structures originally retrieved by the text processing component 214 met the needs of the customer. In the analysis, the agent 228 may enter one or more items of information, for the analysis tools component 216, about the response and about how the response matched with the dialog data structures. The analysis tools component 216 can review the response and determine if it was similar to the response provided by the dialog data structure. Thus, the analysis tools component 216 can provide information to the dialog core 210 or the dialog creator 220 to improve the dialog data structures that are included in the heuristic rules and dialogs database 218.

The message history database 222 can be any database or data storage system as described in conjunction with FIGS. 7 and 8. Thus, the message history database 222 can store data in data fields, objects, or other data structures to allow other systems to retrieve that information at a later time. The message history database 222 can store previous messages or information about previous messages. Thus, for example, if the trend analysis component 212 is analyzing several messages over a period of time, the trend analysis component 212 can retrieve information about previous messages associated with the current analysis from the message history database 222. As such, the trend analysis component 212 can better detect trends occurring at the social media networks 140, 144, and/or 148. The data stored by the message history database 222 can include the entire message or only a portion of the message, and in some circumstances, include metadata about the message(s).

The heuristic rules and dialogs database 218 can be any type of database or data storage system as described in conjunction with FIGS. 7 and 8. The heuristic rules and dialogs database 218 can store information in data fields, data objects, and/or any other data structures. The heuristic rules and dialogs database 218 stores rules and dialogs data structures that automate responses to received social media messages. The dialogs data structures control the interaction between the dialog core 210 and the social media network 140, 144, and/or 148. The dialogs or heuristic rules can be created by a dialog creator 220. Thus, the dialog creator 220 can interface with user input 226 to receive information about dialogs. The user input 226 is then used to form the states and responses for a dialog data structure.

An agent interface 224 is a communication system operable to send action items to contact center agents 228, in the contact center 116. An agent can be a person or other system that is operable to respond to certain questions or requests from a customer. For example, the agent 228 can be a person that has specialized expertise in a topic area, such as technical support. The agent interface 224 can format the social message into an action item and forward that message to one or more agents 228. The agent interface 224 can also receive response(s) back from the agents 228. The information provided by the agent 228 may be used by the dialog core 210 to complete a response to the social media message or other contact. For example, the information may classify the social media message (e.g., sales, service, etc.). In other situations, the response is a complete response to the social media message that can be posted to the social media network 140, 144, and/or 148. It should be noted that the answer based agent routing described hereinafter may be implemented in other types of call center or customer service centers other than that previously described. Thus, the answer based agent routing systems and methods described hereinafter are not limited to the social media call center described above.

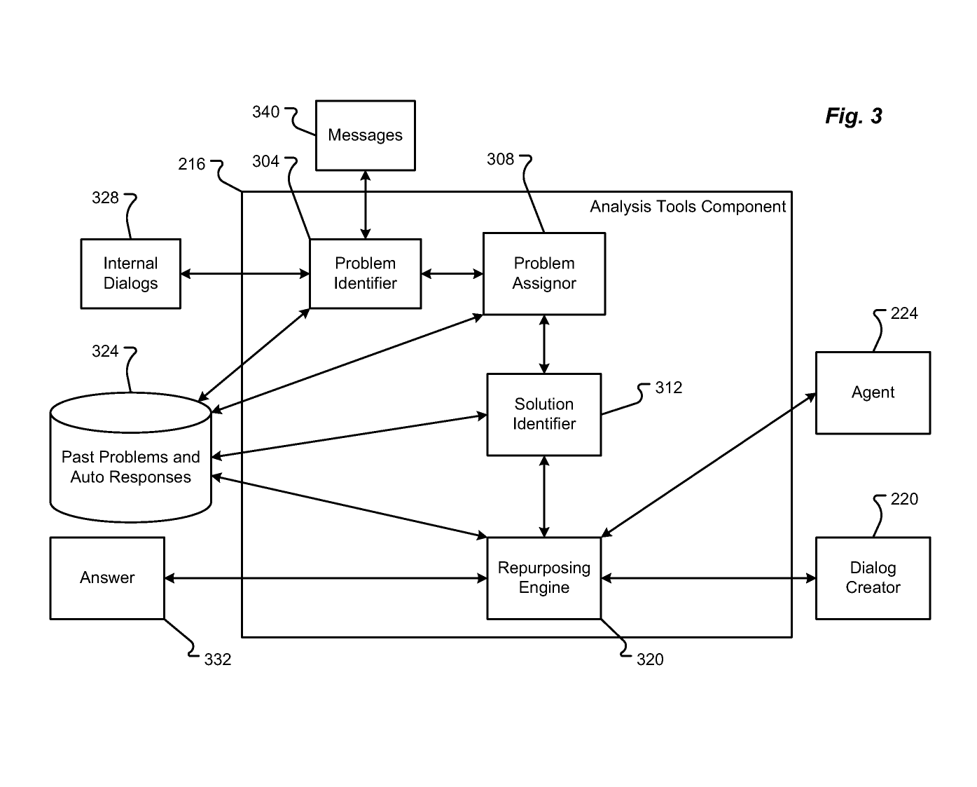

An embodiment of an analysis tools component 216 is shown in FIG. 3A. The analysis tools component 216 can include one or more modules that perform different functions. These modules may be embodied in hardware, software, and/or hardware and software. The analysis tools component 216 can include a problem identifier 304, a problem assignor 308, a solution identifier 312, and/or a repurposing engine 320. These modules 304 through 320 may communicate, retrieve, store, and/or manage data in one or more databases. For example, the modules 304 through 320 may communicate with past problems and auto responses database 324.

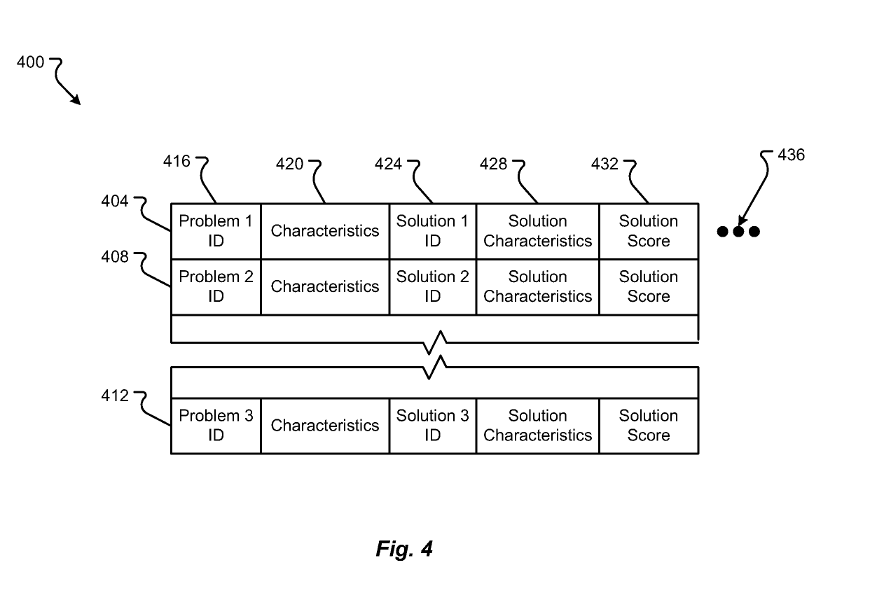

The problem identifier module 304 may receive either internal dialogs 328 or messages 340. The internal dialogs 328 can include any kind of discussion or information about a question that needs to be answered based on in-company or in-organization information. These dialogs 328 may be transcripts of meetings, may be a posed question, may be a trigger or marking in a script to indicate something either not working or needs further clarification. This internal information may be scanned, by the problem identifier module 304, to identify the problem and produce characteristics for the problem to place in the database 324. An embodiment of the problem information stored in the database 324 may be as shown in FIG. 4.

The problem identifier module 304 may also receive messages 340. These messages 340 may be social media postings or other types of social media data that may be scanned by the problem identifier 304. The problem identifier module 304 may extract information from the database 324 to identify certain problems within the external messages 340. The problems, once identified, may then be provided to the problem assignor module 308.

The problem assignor module 308 may determine any type of problem associated with a question or information identified by the problem identifier module 304. The problem assignor 308 can also evaluate raw problems identified by the problem identifier module 304 and match those problems with information in the past problems database 324. Any information extracted from the process of matching the problems to past information 324 may be provided to a solution identifier 312.

A solution identifier module 312 can scan the social media information provided by the problem assignor 308 to determine if a user has posted a possible solution to the problem in social media. Thus, once the problem is identified, the solution identifier 312 may look at responses or other information associated with the problem to determine if a user has determined a solution for the identified problem. The solution may be rated, may be characterized, and then may be stored, by the solution identifier module 312, in the past problems and auto response database 324. The information stored about the identified solution may be as shown in FIG. 4. The solution may then be provided to the repurposing engine 320.

The repurposing engine 320 may provide the answer to other social media sites or to other interested parties where the problem was identified. In effect, the repurposing engine 320 acts like a broker questions and answers (i.e., remedies or other information). With the repurposing engine 320, company employees can have their questions indirectly answered by customers, and customers can have their questions answered indirectly by other customers or by employees. Thus, the repurposing engine 320 can quote the solution to the other social media users to answer their questions. Further, the repurposing engine 320 may provide the information to the heuristic rules and dialogs database 218, or the dialogue creator 220, to change any script or dialogue used to answer the identified problem(s). Thus, the repurposing engine 320 may utilize the identified solution to update future scripts or automated responses when the problem is identified in the future. Further, the repurposing engine 320 may provide the solution to an agent 332, which was asking or created the review of the social media for a possible solution. Thus, this agent 332 or the supervisor of the agent 332 may be able to use the answer in future responses when the problem is identified in future communications with users.

A database 400 for storing information about past problems and determined or identified solutions is shown in FIG. 4. The database 400 can include one or more rows 404 through 412, which can include data about one or more identified problems and/or one or more solutions associated with those identified problems. Each row may be associated with a single problem. The rows may have one or more fields of data, which can include, but are not limited to, a problem identifier (ID) 404, problem characteristics 408, a solution ID 412, solutions characteristics 416, a solution score 420, etc. The database 400 may include more or fewer fields than those shown in FIG. 4, as represented by ellipses 436. Each problem 404 through 412 may have one or more solutions associated with the problem. As such, there may be more solutions identified and characterized in fields, such as fields 424 through 432, than those shown in FIG. 4.

The problem ID 416 can be any identifier that uniquely identifies that problem amongst all problems located by the problem identifier 304 or provided to the database 400. Thus, the problem identifier 416 can be a globally unique identifier (GUID), a numeric identifier, an alphanumeric identifier, etc. The problem identifiers 416 allow for identifying the problem and using that ID to locate and store that problem for future use. The problem ID 416 can include other information, such as, who the poster was, a product, a service, or other types of information that may be associated with the organization. Thus, beyond being a simple identifier, the problem identifier 416 may also include one or more items of information that can associate the problem with another product or service.

Problem characteristics 420 may be metadata or other information that characterizes or describes the problem identified by ID 416. The characteristics 420 can include information about word usage, associations with other information, phrase usage, users, or other information that can characterize the problem. The problem characteristics information 420 can also include information about the poster and any information about the original posting, for example, either text or other media for the problem. Further, the characteristics 420 can be changed as the problem is located in other social media sites or at different times. Thus, the characteristics 420 may be refined over a period of time to better characterize the problem.

The solution identifier 424 can be any ID that uniquely identifies a solution among other solutions in the database 400. Thus, the solution ID can be a GUID, an alphanumeric identifier, a numeric identifier, etc. The solution ID may also include other information that can associate the solution with the problem 416.

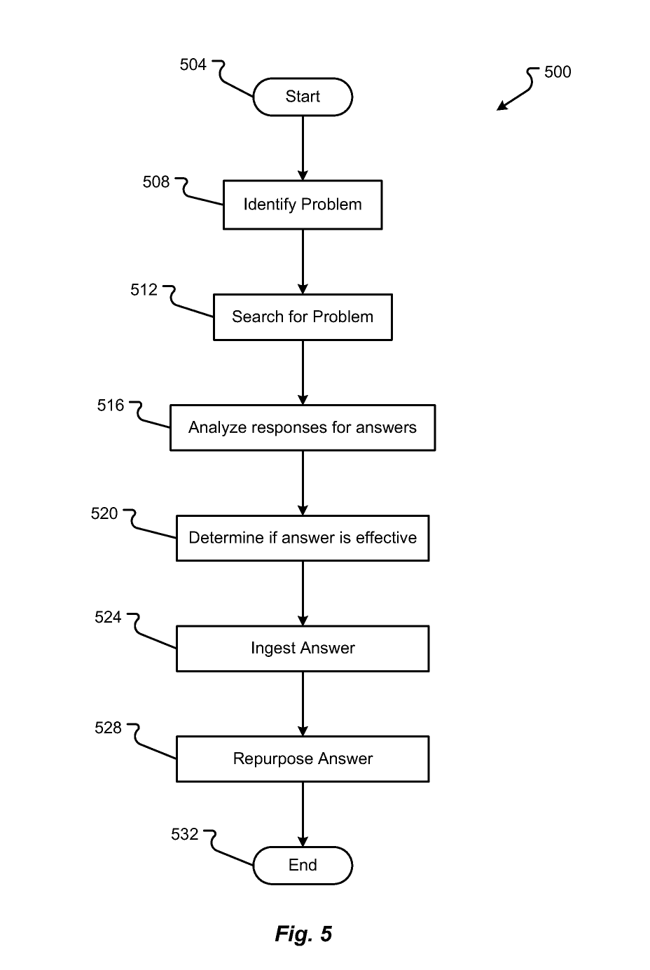

The solution characteristics 428 can include any information about the solution identified in field 424. Thus, the solution characteristics 428 can include any type of phrases, words, dates, users, or other metadata and other information that helps characterize the solution. The solution characteristics 428 may also provide the actual text of the solution such that that text or other media may be used in future responses. In other words, the solution characteristics 428 includes all information needed by the agent analysis tool component 216 to repurpose that solution for other situations as explained in conjunction with FIGS. 3, 5, and/or 6.

The solution score 432 can include some type of quantitative analysis of the solution. This quantitative analysis may be used to better determine which solution is the most efficacious. The solution score 432 may be based on positive responses about the solution or other information contained in the social media. Further, the solution score 432 can also be based on statistics or feedback received by the organization from agents or other channels of communication. This information can score the solution identified by identifier 424. As such, if there are two or more solutions associated with the problem ID 416, the solution score 432 may be used to sort or order those solutions from the most efficacious to the least efficacious.

An embodiment of a method 500 for locating and repurposing solutions to problems may be as shown in FIG. 5. Generally, the method 500 begins with a start operation 504 and terminates with an end operation 532. While a general order for the steps of the method 500 are shown in FIG. 5, the method 500 can include more or fewer steps or arrange the order of the steps differently than those shown in FIG. 5. The method 500 can be executed as a set of computer-executable instructions, executed by a computer system, and encoded or stored on a computer readable medium. Further, the method 500 can be executed by a gate or other hardware device or component in an Application Specific Integrated Circuit, a Field Programmable Gate Array, or other type of hardware device. Hereinafter, the method 500 shall be explained with reference to the systems, components, modules, software, data structures, user interfaces, etc. described herein.

A problem identifier module 304 may identify a problem, in step 508. The problem identifier 304 may scan or review messages 340 sent to the dialogue core 210 from the social media gateway 156. In other embodiments, the problem identifier 304 may scan social media websites for problems. The problem identifier 304 and/or the problem assignor 308 may have a known problem to find or be searching for negative comments or other language that may indicate that there is a problem that needs to be targeted. Further or in the alternative, internal dialogs 324 may be provided to the problem identifier 304 and/or the problem assignor 308 to characterize the problem that needs to be identified. Still further or in the alternative, past problems may be accessed from database 324 and searched. The searching for past problems 324 may be done periodically to determine if there may be a problem for which to find a solution. Once the problem is identified, the problem identifier 304 and/or the problem assignor 308 may then search for those problems in the social media information.

The problem identifier 304 and/or the problem assignor 308 can search for problems in social media information 340, in step 512. Using the characteristics from the problem database 324 or other information, the problem identifier 304 and/or the problem assignor 308can determine if an instance of a problem has occurred in a social media interaction. The identified problem and the associated information may then be passed to the solution identifier 312.

The solution identifier module 312 may then analyze responses in the social media information associated with the identified problem for an answer, in step 516. Here, the solution identifier 312 can attempt to identify a solution provided by another user or someone in the public. If a solution is identified by the characteristics of the language, phrases, words, or other information associated with the solution, that solution information may then be scanned to determine how effective the answer was or is, in step 520. The solution identifier 312 may determine from responses to the solution or other information whether that solution was effective for addressing the problem. The solution information may then be stored in the past problems and auto response database 324, as described in conjunction with FIG. 4.

The solution identifier 312 can ingest the answer, in step 524. In digesting the answer, the solution identifier 312 can extract any data or metadata about the identified solutions and store that information in the database 400. The solution identifier 312 can create an ID 429 and solution characteristics, including the text or solution information 428. Further, the solution identifier 312 may record some statistics or other information that provide a solution score 432. This information can be stored in the database 400 for use in subsequent interactions in different social media.

The repurposing engine 320 may then repurpose the answer, in step 528. The repurposing engine 320 may extract the response and provide that response to the dialogue creator 220 to change scripts or other information used by agents. Thus, the repurposing engine 320 may borrow the solution provided by the public or outside user to change the interaction, or future interactions, of agents with other people. Further or in the alternative, the repurposing engine 320 may provide the answer to an agent either addressing the problem currently, or having requested information of possible solutions. Thus, the repurposing engine 320 can send the solution information to the agent for the agent to react to or to use the answer and solution information. Further or in the alternative, the repurposing engine 320 can provide the answer automatically to other users with the same problem. Thus, if the problem identifier 304 has identified a reoccurrence of the problem, the repurposing engine 320 may extract the response from the database 324 and provide that answer automatically in a social media posting to the location associated with the identified problem. The repurposing engine 320 may also use these solutions for other purposes, as would be understood in the art.

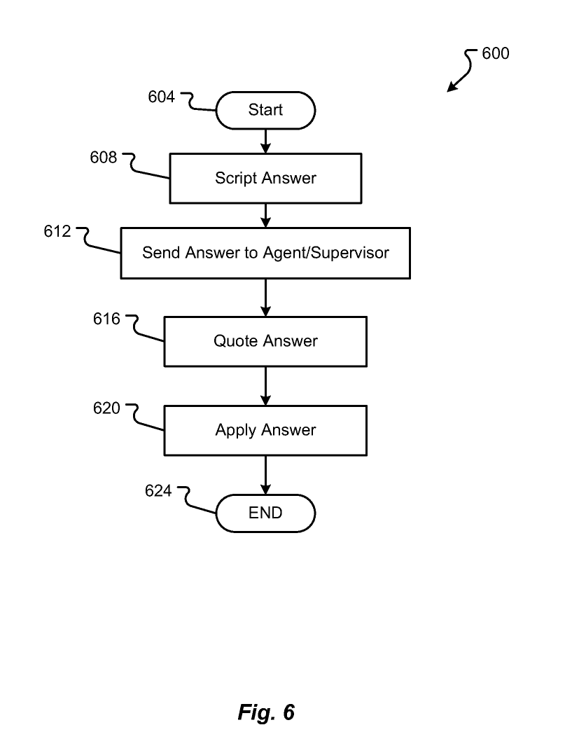

An embodiment of a method 600 for repurposing a solution is shown in FIG. 6. Generally, the method 600 begins with a start operation 604 and terminates with an end operation 624. While a general order for the steps of the method 600 are shown in FIG. 6, the method 600 can include more or fewer steps or arrange the order of the steps differently than those shown in FIG. 6. The method 600 can be executed as a set of computer-executable instructions, executed by a computer system, and encoded or stored on a computer readable medium. Further, the method 600 can be executed by a gate or other hardware device or component in an Application Specific Integrated Circuit, a Field Programmable Gate Array, or other type of hardware device. Hereinafter, the method 600 shall be explained with reference to the systems, components, modules, software, data structures, user interfaces, etc. described herein.

A repurposing engine 320 can provide the identified solution to the dialogue creator 220 to script an answer, in step 608. Here, the dialogue creator 220 may change a script or information in the heuristic rules or dialogs database 218 to include the identified solution. This new or modified dialogue may then be updated for use by other agents 228 in future interactions. Further or in the alternative, the automated dialogs used to provide that answer automatically in return postings to social media may also be updated.

The repurposing engine 320 may also send the answer to an agent or supervisor, in step 612. Based on internal dialogs 328, or other information, one or more agents or supervisors may be interested in any possible solutions to the identified problem. The repurposing engine 320 may provide that answer, if discovered, to the agent or supervisor in email or other interaction. The provided answer may then be used by the agent or supervisor to update dialogs or to change the internal dialogue 328.

The repurposing engine 320 may also quote the answer, in step 616. Here, if the problem is being addressed currently when the answer is provided or discovered, the repurposing engine 320 may quote that answer in a dialogue on social media. In other words, the repurposing engine 320 can provide the exact text, or substantially similar text, to that which was discovered in the posted solution to answer a problem that is similar to the problem previously identified. The quoting of the answer may also provide any information about the original poster that provided the solution, the time when the solution was provided, a social media site to which the solution was provided, or other information associated with the identified solution. The repurposing engine 320 may also quote the answer in subsequent dialogs that don't happen in real time when the solution is identified.

The repurposing engine 320 may also apply the answer, in step 620. Here, the answer may be characterized or redeveloped into a different form and applied to a current dialogue or future dialogue. Thus, the repurposing engine 320 can change the text or media provided with the solution to paraphrase or better structure the solution and provide that newly scripted solution to an agent 224 or script 218. Thus, the answer is applied in different forms but may not be quoted as what occurs in step 616.

FIG. 7 illustrates a block diagram of a computing environment 700 that may function as servers, computers, or other systems provided herein. The environment 700 includes one or more user computers 705, 710, and 715. The user computers 705, 710, and 715 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 705, 710, 715 may also have any of a variety of applications, including for example, database client and/or server applications, and web browser applications. Alternatively, the user computers 705, 710, and 715 may be any other electronic device, such as a thin-client computer, Internet-enabled mobile telephone, and/or personal digital assistant, capable of communicating via a network 720 and/or displaying and navigating web pages or other types of electronic documents. Although the exemplary computer environment 700 is shown with three user computers, any number of user computers may be supported.

Environment 700 further includes a network 720. The network 720 may can be any type of network familiar to those skilled in the art that can support data communications using any of a variety of commercially-available protocols, including without limitation SIP, TCP/IP, SNA, IPX, AppleTalk, and the like. Merely by way of example, the network 720 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 702.11 suite of protocols, the Bluetooth™ protocol known in the art, and/or any other wireless protocol); and/or any combination of these and/or other networks.

The system may also include one or more server 725, 730. In this example, server 725 is shown as a web server and server 730 is shown as an application server. The web server 725, which may be used to process requests for web pages or other electronic documents from user computers 705, 710, and 715. The web server 725 can be running an operating system including any of those discussed above, as well as any commercially-available server operating systems. The web server 725 can also run a variety of server applications, including SIP servers, HTTP servers, FTP servers, CGI servers, database servers, Java servers, and the like. In some instances, the web server 725 may publish operations available operations as one or more web services.

The environment 700 may also include one or more file and or/application servers 730, which can, in addition to an operating system, include one or more applications accessible by a client running on one or more of the user computers 705, 710, 715. The server(s) 730 and/or 725 may be one or more general purpose computers capable of executing programs or scripts in response to the user computers 705, 710 and 715. As one example, the server 730, 725 may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 730 may also include database servers, including without limitation those commercially available from Oracle, Microsoft, Sybase™, IBM™ and the like, which can process requests from database clients running on a user computer 705.

The web pages created by the server 725 and/or 730 may be forwarded to a user computer 705 via a web (file) server 725, 730. Similarly, the web server 725 may be able to receive web page requests, web services invocations, and/or input data from a user computer 705 and can forward the web page requests and/or input data to the web (application) server 730. In further embodiments, the web server 730 may function as a file server. Although for ease of description, FIG. 6 illustrates a separate web server 725 and file/application server 730, those skilled in the art will recognize that the functions described with respect to servers 725, 730 may be performed by a single server and/or a plurality of specialized servers, depending on implementation-specific needs and parameters. The computer systems 705, 710, and 715, web (file) server 725 and/or web (application) server 730 may function as the system, devices, or components described in FIGS. 1-4.

The environment 700 may also include a database 735. The database 735 may reside in a variety of locations. By way of example, database 735 may reside on a storage medium local to (and/or resident in) one or more of the computers 705, 710, 715, 725, 730. Alternatively, it may be remote from any or all of the computers 705, 710, 715, 725, 730, and in communication (e.g., via the network 720) with one or more of these. The database 735 may reside in a storage-area network (“SAN”) familiar to those skilled in the art. Similarly, any necessary files for performing the functions attributed to the computers 705, 710, 715, 725, 730 may be stored locally on the respective computer and/or remotely, as appropriate. The database 735 may be a relational database, such as Oracle 10i™, that is adapted to store, update, and retrieve data in response to SQL-formatted commands.

FIG. 8 illustrates one embodiment of a computer system 800 upon which the servers, computers, or other systems or components described herein may be deployed or executed. The computer system 800 is shown comprising hardware elements that may be electrically coupled via a bus 855. The hardware elements may include one or more central processing units (CPUs) 805; one or more input devices 810 (e.g., a mouse, a keyboard, etc.); and one or more output devices 815 (e.g., a display device, a printer, etc.). The computer system 800 may also include one or more storage devices 820. By way of example, storage device(s) 820 may be disk drives, optical storage devices, solid-state storage devices such as a random access memory (“RAM”) and/or a read-only memory (“ROM”), which can be programmable, flash-updateable and/or the like.

The computer system 800 may additionally include a computer-readable storage media reader 825; a communications system 830 (e.g., a modem, a network card (wireless or wired), an infra-red communication device, etc.); and working memory 840, which may include RAM and ROM devices as described above. The computer system 800 may also include a processing acceleration unit 835, which can include a DSP, a special-purpose processor, and/or the like.

The computer-readable storage media reader 825 can further be connected to a computer-readable storage medium, together (and, optionally, in combination with storage device(s) 820) comprehensively representing remote, local, fixed, and/or removable storage devices plus storage media for temporarily and/or more permanently containing computer-readable information. The communications system 830 may permit data to be exchanged with the network 820 (FIG. 8) and/or any other computer described above with respect to the computer system 800. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 800 may also comprise software elements, shown as being currently located within a working memory 840, including an operating system 845 and/or other code 850. It should be appreciated that alternate embodiments of a computer system 800 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments have been described in detail herein, it is to be understood that the inventive concepts may be otherwise variously embodied and employed, and that the appended claims are intended to be construed to include such variations, except as limited by the prior art.

What is claimed is:

1. A method comprising:
a processor detecting a problem associated with a social media message;
the processor identifying a solution provided for the problem in social media associated with the social media message; and
the processor automatically repurposing the solution.

2. The method as defined in claim 1, wherein the problem is a concern of a customer or person about a company's product or service.

3. The method as defined in claim 2, wherein the solution is information or media that addresses the concern.

4. The method as defined in claim 1, wherein the problem is characterized using an internal dialog of a company.

5. The method as defined in claim 1, wherein the problem is previously identified in a previous social media message.

6. The method as defined in claim 1, wherein characteristics of the problem are retrieved from a database to detect the problem in the social media message.

7. The method as defined in claim 6, wherein the solution is stored in the database.

8. The method as defined in claim 7, wherein repurposing the solution includes changing a script or dialog used by an agent or by a system to respond to the problem.

9. The method as defined in claim 7, wherein repurposing the solution includes quoting the solution in response to a second social media message, generated by a second customer, also including the problem.

10. The method as defined in claim 7, wherein repurposing the solution includes providing the solution to an agent to respond to a customer or to respond to a query by the agent.

11. A computer readable medium having stored thereon processor executable instructions that cause a computing system to execute a method, the instructions comprising:
instructions to identify a problem associated with a customer of a company;
instructions to detect the problem associated with a social media message;
instructions to identify a solution provided for the problem in social media associated with the social media message;
instructions to store the solution in a database; and
instructions to repurpose automatically the solution.

12. The computer readable medium as defined in claim 11, wherein the problem is a concern of the customer about a company's product or service, and wherein the solution is information or media that addresses the concern.

13. The computer readable medium as defined in claim 12, wherein the problem is identified by one of:
characteristics found in an internal dialog of the company; or
characteristics found in a previous social media message that identified the problem.

14. The computer readable medium as defined in claim 13, wherein the characteristics of the problem are retrieved from the database to detect the problem in the social media message.

15. The computer readable medium as defined in claim 14, wherein repurposing the solution includes one of:
changing a script or dialog used by an agent or by a system to respond to the problem;
quoting the solution in response to a second social media message also including the problem; or
providing the solution to the agent to respond to the customer.

16. A communication system comprising:
a social media gateway in communication with a social media network, the social media gateway operable to receive a social media message on the social media network;
a dialog system in communication with the social media gateway, the dialog system operable to analyze the social media message, wherein the dialog system compromises:
an analysis tools component that is operable to receive and analyze the social media message, wherein the analysis tools component compromises:
a problem identifier operable to identify a problem associated with a customer of a company;
a problem assignor operable to detect the problem associated with a social media message
a solution identifier operable to:
identify a solution provided for the problem in social media associated with the social media message;
store the solution in a database; and
a repurposing engine operable to repurpose automatically the solution.

17. The communication system as defined in claim 16, wherein the problem is a concern of the customer about a company's product or service, and wherein the solution is information or media that addresses the concern.

18. The communication system as defined in claim 17, wherein the problem identifier identifies the problem by one of:
characteristics found in an internal dialog of the company; or
characteristics found in a previous social media message that identified the problem.

19. The communication system as defined in claim 18, wherein the problem assignor retrieves the characteristics of the problem from the database to detect the problem in the social media message.

20. The communication system as defined in claim 19, wherein the repurposing engine repurposes the solution by one of:
changing a script or dialog used by an agent or by a system to respond to the problem;
quoting the solution in response to a second social media message also including the problem; or
providing the solution to the agent to respond to the customer.
